(19) United States
(12) Patent Application Publication
(10) Pub. No.: US 2025/0199247 A1
(43) Pub. Date: Jun. 19, 2025

(54) OPTICAL CONNECTION UNIT

(71) Applicant: Fujikura Ltd., Tokyo (JP)

(72) Inventor: Akihiro Nakama, Sakura-shi (JP)

(73) Assignee: Fujikura Ltd., Tokyo (JP)

(21) Appl. No.: 18/849,798

(22) PCT Filed: Nov. 22, 2022
(86) PCT No.: PCT/JP2022/043170

§ 371 Date: Sep. 23, 2024

(30) Foreign Application Priority Data
Mar. 24, 2022 (JP) 2022-048415

(51) Int. Cl. G02B 6/38

(52) U.S. Cl. CPC G02B 6/3853

(57) ABSTRACT

An optical connection unit connected to a photonic integrated circuit, includes: optical fibers having different mode field diameters; a ferrule that holds the optical fibers; a ferrule-side microlens array that transmits optical signals from distal end surfaces of the optical fibers held by the ferrule toward the photonic integrated circuit; and light adjustment units in the ferrule-side microlens array that respectively correspond to the optical fibers. The light adjustment units vary in shape depending on the mode field diameters such that the optical signals transmitted through the light adjustment units become parallel light.

### TECHNICAL FIELD

The present invention relates to an optical connection unit.

Priority is claimed on Japanese Patent Application No. 2022-048415, filed Mar. 24, 2022, the content of which is incorporated herein by reference.

### BACKGROUND

For example, Patent Document 1 discloses an optical connection structure including a substrate, a photonic integrated circuit, and a ferrule into which an optical fiber is inserted.

### PATENT LITERATURE

Patent Document 1: United States Patent Application, Publication No. 2021/0055489

In the related art, a technology of connecting a plurality of electronic substrates with an optical fiber has been used for the purpose of accelerating data communication. In order to further accelerate the data communication, a co-packaged optics (CPO) structure in which an optical fiber is brought into contact with and directly connected to a photonic integrated circuit mounted on an electronic substrate has been attracting attention (see, for example, Patent Document 1).

Such a CPO structure includes a CPO structure having a structure in which a plurality of optical fibers are held by the same ferrule and these plurality of optical fibers are collectively connected to a photonic integrated circuit. Further, in the ferrule, a plurality of types of optical fibers having different mode field diameters may be held. Therefore, it is necessary to match the forms of the optical signal incident on the optical fiber and the optical signal emitted from the optical fiber to the photonic integrated circuit side for each type of the optical fiber such that the splice loss between each type of optical fibers and the photonic integrated circuit is reduced. It is noted that matching the configuration on the photonic integrated circuit side for each type of the optical fiber held by the ferrule is considered, but the forms of the optical signals on the ferrule side may be matched as much as possible.

### SUMMARY

One or more embodiments of the present invention provide an optical connection unit capable of reducing a splice loss between a plurality of types of optical fibers having different mode field diameters and a photonic integrated circuit without changing a form of the photonic integrated circuit.

An optical connection unit according to one or more embodiments of the present invention is an optical connection unit connected to a photonic integrated circuit, the optical connection unit including: a plurality of types of optical fibers having different mode field diameters; a ferrule that holds the plurality of types of optical fibers; a ferrule-side microlens array that transmits optical signals from distal end surfaces of the optical fibers held by the ferrule toward the photonic integrated circuit; and a plurality of light adjustment units that are disposed in the ferrule-side microlens array and respectively correspond to the plurality of types of optical fibers, wherein forms (i.e., the shape) of the plurality of light adjustment units vary depending on the mode field diameters such that the optical signals transmitted through the light adjustment units are parallel light.

According to the present invention, it is possible to reduce the splice loss between the plurality of types of optical fibers and the photonic integrated circuit without changing the form of the photonic integrated circuit.

### BRIEF DESCRIPTION OF THE DRAWINGS

FIG. 1 A perspective view showing an entirety of an optical connection structure including an optical connection unit according to first embodiments.

FIG. 2 A cross-sectional view showing a state in which the optical connection unit of FIG. 1 is connected to a photonic integrated circuit.

FIG. 3 A view showing a circuit-side microlens array of FIG. 2 as viewed from a rear side thereof.

FIG. 4 A view of the ferrule-side microlens array of FIG. 2 as viewed from a front end surface side thereof.

FIG. 5 A cross-sectional view showing main parts of the optical connection unit and the photonic integrated circuit of FIG. 2.

FIG. 6 A cross-sectional view showing a first example of an optical connection unit according to second embodiments and a main part of a photonic integrated circuit.

FIG. 7 A cross-sectional view showing a second example of the optical connection unit according to the second embodiments and a main part of the photonic integrated circuit.

### DETAILED DESCRIPTION

### First Embodiments

Hereinafter, an optical connection unit according to first embodiments will be described with reference to the accompanying drawings.

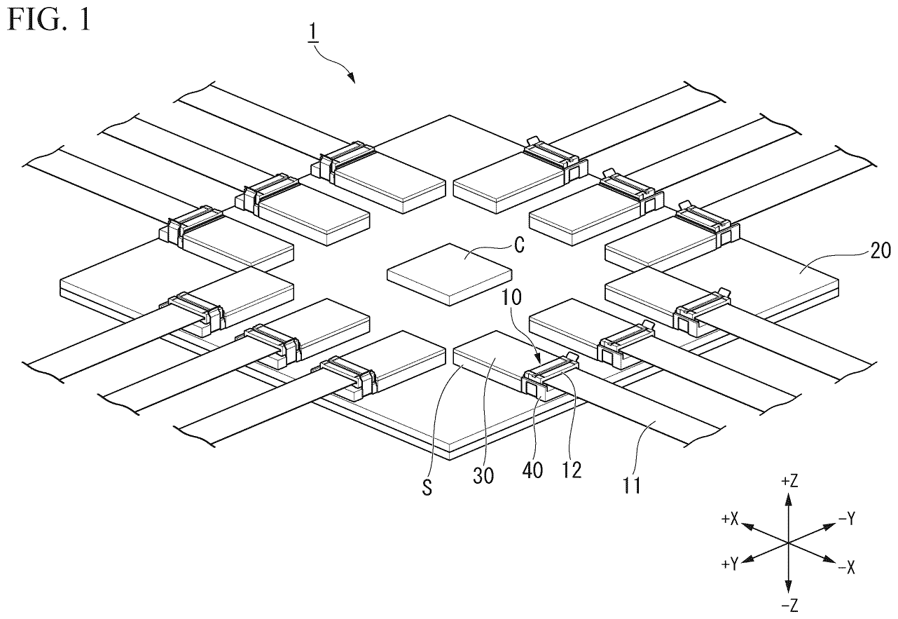

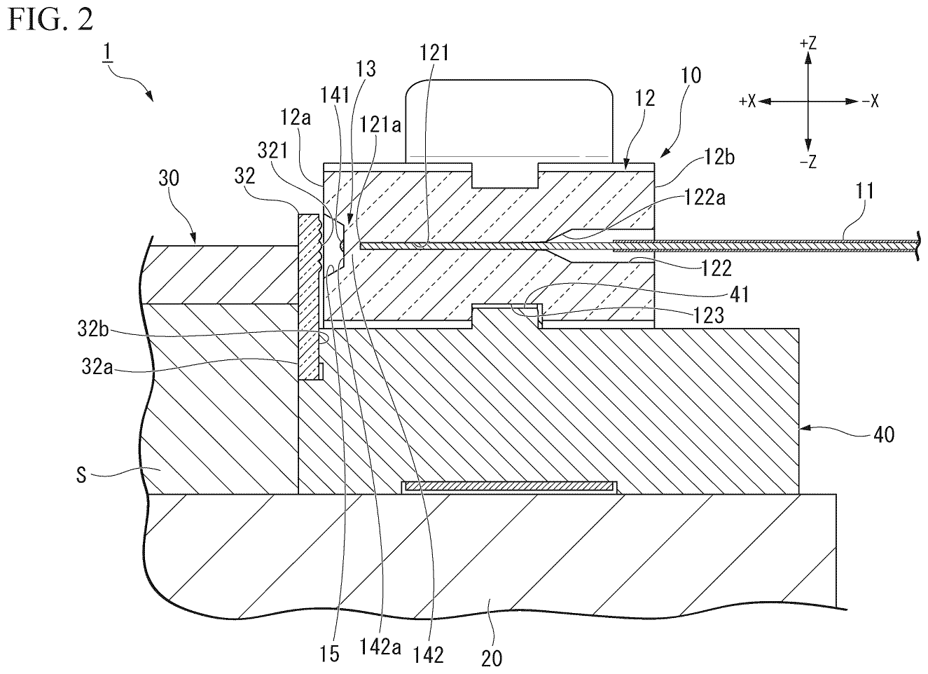

As shown in FIGS. 1 and 2, an optical connection unit 10 configures an optical connection structure 1 together with a photonic integrated circuit 30 provided on a substrate 20. The optical connection structure 1 includes the substrate 20, the photonic integrated circuit 30, the optical connection unit 10, and a receptacle 40. The optical connection unit 10 includes a plurality of optical fibers 11, and a ferrule 12 that holds the plurality of optical fibers 11. Details will be described below, but a plurality of fiber holes 121 into which the plurality of optical fibers 11 can be inserted respectively are formed in the ferrule 12. The plurality of fiber holes 121 are arranged along one direction orthogonal to the longitudinal direction of each fiber hole 121.

### Direction Definition

In one or more embodiments, the XYZ Cartesian coordinate system is set and the positional relationship between components is described. The X axis direction is a direction along the longitudinal direction of the fiber hole 121. The Y axis direction is a direction in which the plurality of fiber holes 121 are arranged. The Z axis direction is a direction in which the substrate 20 and the photonic integrated circuit 30 are arranged side by side. In the present specification, the X axis direction may be referred to as a longitudinal direction X, the Y axis direction may be referred to as a first direction Y, and the Z axis direction may be referred to as a second direction Z. A direction from the optical connection unit 10 toward the photonic integrated circuit 30 along the longitudinal direction X is referred to as a +X direction or a forward direction. A direction opposite to the +X direction is referred to as a −X direction or a rearward direction. A direction along the first direction Y is referred to as a +Y direction or a left direction. A direction opposite to the +Y direction is referred to as a −Y direction or a right direction. A direction from the substrate 20 toward the photonic integrated circuit 30 along the second direction Z is referred to as a +Z direction or an upward direction. A direction opposite to the +Z direction is referred to as a −Z direction or a downward direction.

As shown in FIG. 1, an electric circuit C and a pattern (not shown) are mounted on the upper surface of the substrate 20. The electric circuit C may be, for example, a switch circuit or the like. In addition, a plurality of the photonic integrated circuits 30 are disposed on the substrate 20. The number of the photonic integrated circuits 30 disposed on the substrate 20 is not limited to the number illustrated in FIG. 1, and can be appropriately changed. The plurality of photonic integration circuits 30 are disposed to surround the electric circuit C. Each photonic integrated circuit 30 is electrically connected to the substrate 20 via a socket S. The photonic integrated circuit 30 may be attachable to and detachable from, for example, the socket S. It is noted that the socket S may be replaced with, for example, a spacer. In this case, the photonic integrated circuit 30 and the substrate 20 may be electrically connected to each other by a wiring (not shown). In addition, the photonic integrated circuit 30 may be directly mounted on, for example, the upper surface of the substrate 20.

In one or more embodiments, the photonic integrated circuit 30 is formed into a rectangular parallelepiped shape. The photonic integrated circuit 30 includes a light receiving element (not shown) that converts an optical signal into an electrical signal, and a light emitting element (not shown) that converts an electrical signal into an optical signal. As the light receiving element, for example, a photo detector such as a photodiode can be used. As the light emitting element, for example, a semiconductor laser, a light emitting diode, or the like can be used.

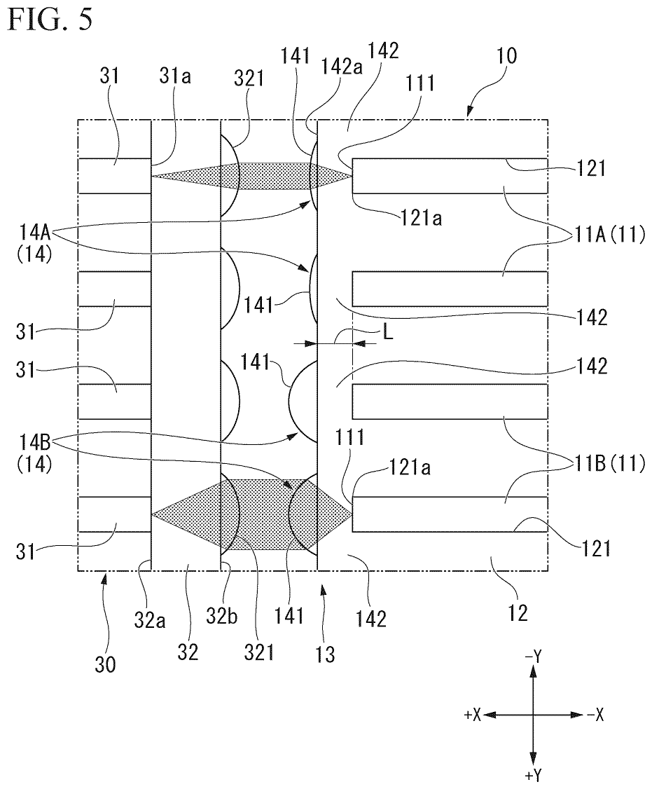

As shown in FIG. 5, the photonic integrated circuit 30 has a plurality of waveguides 31. The mode field diameters of the plurality of waveguides 31 are equal to each other. The plurality of waveguides 31 are arranged in a first direction Y. Each waveguide 31 is optically connected to the above-described light receiving element and light emitting element. Each waveguide 31 extends along the longitudinal direction X. Each waveguide 31 is formed of, for example, silicon. The refractive index of the waveguide 31 is higher than the refractive index of a portion other than the waveguide 31 in the photonic integrated circuit 30. Thus, the optical signal is confined inside the waveguide 31, and the optical signal propagates in the longitudinal direction X. The waveguide 31 may be provided on a surface (upper surface) of the photonic integrated circuit 30, or may be provided inside the photonic integrated circuit 30. An incidence and exit portion 31a is provided at a rear end of each waveguide 31. The incidence and exit portion 31a is a part of the waveguide 31 and receives and transmits the optical signal.

The incidence and exit portion 31a receives an optical signal transmitted from the optical fiber 11, which will be described below. The optical signal received by the incidence and exit portion 31a propagates through the waveguide 31. Further, the optical signal is converted into an electrical signal by the light receiving element of the photonic integrated circuit 30 and the converted electrical signal is transferred to the substrate 20. In addition, the electrical signal transmitted from the substrate 20 to the photonic integrated circuit 30 is converted into an optical signal by the light emitting element of the photonic integrated circuit 30. Further, the optical signal propagates through the waveguide 31 and is transmitted from the incidence and exit portion 31a toward the optical fiber 11.

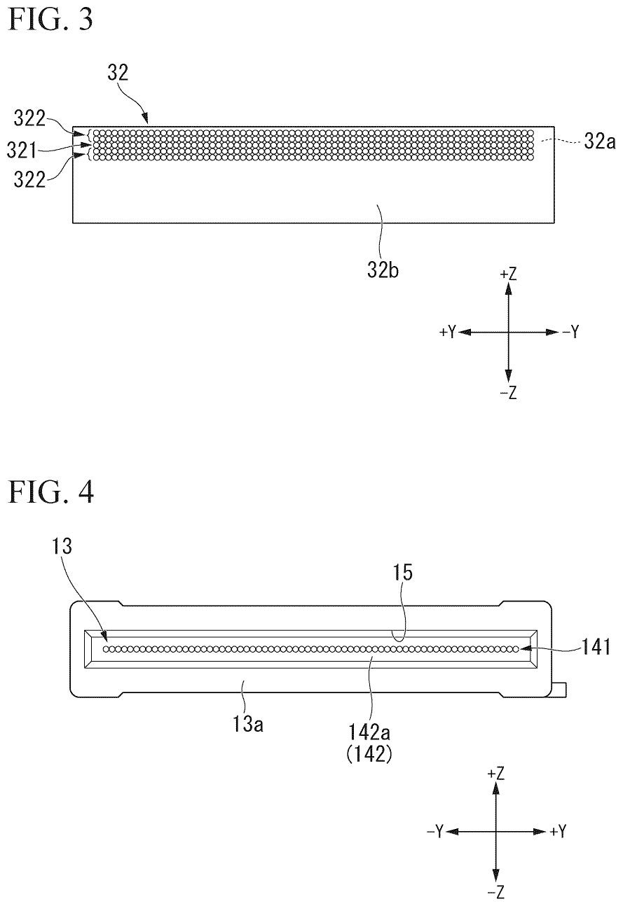

As shown in FIGS. 2 and 3, the photonic integrated circuit 30 includes a circuit-side microlens array 32. The circuit-side microlens array 32 is formed of a member through which light can be transmitted. The circuit-side microlens array 32 may be formed of, for example, silica glass or a silicon substrate. In one or more embodiments, the circuit-side microlens array 32 is formed into a plate shape in which the longitudinal direction X is the thickness direction. The circuit-side microlens array 32 includes a front surface 32a, and a rear surface 32b.

A plurality of circuit-side lenses 321 (circuit-side lens group 321) and a plurality of dummy lenses 322 (dummy lens group 322) are formed on the rear surface 32b of the circuit-side microlens array 32.

As shown in FIG. 5, the number of the circuit-side lenses 321 is the same as the number of the waveguides 31 (the incidence and exit portions 31a). The plurality of circuit-side lenses 321 are arranged in the first direction Y in the same manner as the waveguides 31. Each one of the plurality of circuit-side lenses 321 and each one of the plurality of waveguides 31 correspond one-to-one. The circuit-side lens 321 is arranged in the longitudinal direction X with respect to the incidence and exit portion 31a. Distances from the incidence and exit portion 31a to the circuit-side lens 321 in the longitudinal direction X are equal to each other between the plurality of circuit-side lenses 321. In one or more embodiments, the optical axis of the circuit-side lens 321 and the optical axis of the waveguide 31 substantially match. It is noted that the term “substantially match” also includes the case where the two optical axes are considered to match in a case in which the manufacturing error is removed. The same applies to the following description. The curvature radii of the plurality of circuit-side lenses 321 are equal to each other.

As shown in FIG. 3, the plurality of dummy lenses 322 are formed above and below the plurality of circuit-side lenses 321. The dummy lens 322 is not used for propagating the optical signal.

The main body portion of the photonic integrated circuit 30 including the plurality of waveguides 31 and the circuit-side microlens array 32, shown in FIGS. 2 and 5, are fixed by an adhesive. Specifically, a front surface 32a of the circuit-side microlens array 32 is adhesively fixed to a rear surface (incidence and exit portions 31a of the plurality of waveguides 31) of the main body portion of the photonic integrated circuit 30. Since the optical signal passes through the layer of the adhesive, the adhesive may transmit light. In order to adjust the propagation characteristics of the optical signal in the layer of the adhesive, the refractive index of the adhesive may be appropriately adjusted.

As shown in FIGS. 1 and 2, the optical connection unit 10 is connected to the photonic integrated circuit 30. In one or more embodiments, the number of the optical connection units 10 corresponds to the number of the photonic integrated circuits 30. In a state where the optical connection unit 10 is connected to the photonic integrated circuit 30, the optical signal can be transmitted and received between the optical fiber 11 of the optical connection unit 10 and the photonic integrated circuit 30.

As shown in FIGS. 2 and 5, the optical connection unit 10 includes a plurality of optical fibers 11, a ferrule 12, a ferrule-side microlens array 13, and a plurality of light adjustment units 14.

The plurality of optical fibers 11 include a plurality of types of optical fibers 11 having different mode field diameters. In one or more embodiments, the optical connection unit 10 has two types of optical fibers 11 (11A and 11B). One optical fiber 11A (first optical fiber 11A) of the two types of optical fibers 11 is a single mode optical fiber. The first optical fiber 11A is used, for example, for receiving an optical signal from the photonic integrated circuit 30. The other optical fiber 11B (second optical fiber 11B) of the two types of optical fibers 11 is a polarization-maintaining optical fiber. A mode field diameter of the polarization-maintaining optical fiber is smaller than a mode field diameter of the single mode optical fiber. The second optical fiber 11B is used, for example, for transmitting an optical signal to the photonic integrated circuit 30. Examples of the polarization-maintaining optical fiber include various types such as a PANDA type, a bow-tie type, and an elliptical clad type.

The ferrule 12 is detachably attached to the receptacle 40 which will be described below. The ferrule 12 holds the plurality of optical fibers 11 (first optical fiber 11A and second optical fiber 11B). The ferrule 12 includes a plurality of fiber holes 121, and a fiber insertion hole 122.

The plurality of fiber holes 121 are arranged in the first direction Y. Each fiber hole 121 extends forward from a fiber insertion hole 122, which will be described below. The optical fiber 11 is inserted into each fiber hole 121. A longitudinal direction of the optical fiber 11 inserted into the fiber hole 121 matches the longitudinal direction X of the fiber hole 121. Each fiber hole 121 has a distal end 121a, and the optical fiber 11 is inserted into the fiber hole 121 up to the distal end 121a. In one or more embodiments, the distal end 121a of each fiber hole 121 is blocked by the ferrule-side microlens array 13, which will be described below.

As shown in FIG. 1, in one or more embodiments, a plurality of optical fibers 11 attached to the same ferrule 12 are collectively coated to form a so-called optical fiber ribbon. It should be noted that the configuration of the optical fiber 11 is not limited to this, and for example, each optical fiber 11 may be individually coated.

As shown in FIG. 2, the fiber insertion hole 122 is a hole that is recessed forward from the rear surface 12b of the ferrule 12. The fiber insertion hole 122 communicates with the plurality of fiber holes 121. In other words, each fiber hole 121 is open to the fiber insertion hole 122. The fiber insertion hole 122 functions as an entrance in a case where the optical fiber 11 is inserted into the fiber hole 121. In one or more embodiments, an inclined surface 122a is formed on a bottom surface (front surface) of the fiber insertion hole 122. The inclined surface 122a is inclined to gradually approach the fiber hole 121 as it goes forward. The inclined surface 122a guides the optical fiber 11 inserted into the fiber insertion hole 122 from the rear surface 12b of the ferrule 12 forward, to the fiber hole 121. It is noted that the ferrule 12 may not have the fiber insertion hole 122 and the inclined surface 122a. In this case, each fiber hole 121 may be open to the rear surface 12b of the ferrule 12.

The ferrule-side microlens array 13 consists of a material through which an optical signal can be transmitted. As shown in FIG. 5, the ferrule-side microlens array 13 transmits the optical signal from the distal end surface 111 of the plurality of optical fibers 11 held by the ferrule 12 toward the photonic integrated circuit 30 and the optical signal from the photonic integrated circuit 30 toward the distal end surface 111 of the plurality of optical fibers 11. The ferrule-side microlens array 13 is disposed to block the distal end 121a of the plurality of fiber holes 121 of the ferrule 12. The ferrule-side microlens array 13 may be disposed, for example, at intervals in front of the distal end 121a of the plurality of fiber holes 121.

The plurality of light adjustment units 14 are disposed in the ferrule-side microlens array 13. The number of the plurality of light adjustment units 14 is the same as the number of the fiber holes 121. The plurality of light adjustment units 14 are arranged in the first direction Y in the same manner as the fiber holes 121. Each one of the plurality of light adjustment units 14 respectively corresponds to each one of the plurality of optical fibers 11 respectively held in each one of the plurality of fiber holes 121 of the ferrule 12. That is, each one of the plurality of light adjustment units 14 and each one of the plurality of optical fibers 11 correspond one-to-one. The light adjustment units 14 are arranged in the longitudinal direction X with respect to the optical fiber 11 (fiber hole 121). The light adjustment unit 14 adjusts the optical signal emitted from the distal end surface 111 of the optical fiber 11 located at the distal end 121a of the fiber hole 121 and the optical signal incident from the outside toward the distal end surface 111 of the optical fiber 11. That is, the light adjustment unit 14 adjusts the optical signal transmitted through the light adjustment unit 14.

Each light adjustment unit 14 includes a ferrule-side lens (lens) 141, and an intermediate portion 142. The ferrule-side lens 141 is disposed to face the distal end surface 111 of the optical fiber 11 located at the distal end 121a of the fiber hole 121 in the longitudinal direction X. That is, each of the plurality of light adjustment units 14 includes the ferrule-side lens 141 that is disposed to face the distal end surface 111 of the optical fiber 11, and the intermediate portion 142 that is provided between the ferrule-side lens 141 and the distal end surface 111 of the optical fiber 11. The ferrule-side lens 141 is disposed such that an optical axis of the ferrule-side lens 141 and an optical axis of the optical fiber 11 substantially match. The ferrule-side lens 141 functions as, for example, a collimating lens. Specifically, the ferrule-side lens 141 adjusts the optical signal such that the optical signals emitted from the distal end surfaces 111 of the optical fibers 11 and having expanded beam diameters is parallel light. In addition, the ferrule-side lens 141 adjusts the optical signal such that the optical signal directed toward the distal end surface 111 of the optical fiber 11 is condensed and then is incident on the distal end surface 111 of the optical fiber 11.

The intermediate portion 142 is provided between the ferrule-side lens 141 and the distal end surface 111 of the optical fiber 11. The ferrule-side lens 141 is disposed on a front surface 142a of the intermediate portion 142 facing forward. The intermediate portion 142 transmits the optical signal between the ferrule-side lens 141 and the distal end surface 111 of the optical fiber 11. The intermediate portion 142 is located between the distal end surface 111 of the optical fiber 11 and the ferrule-side lens 141, so that the distal end surface 111 of the optical fiber 11 and the ferrule-side lens 141 are located with an interval therebetween.

The intermediate portions 142 of the plurality of light adjustment units 14 are arranged in the first direction Y and are integrally formed.

As shown in FIGS. 2 and 4, in one or more embodiments, a front surface 142a of the plurality of intermediate portions 142 in which the plurality of ferrule-side lenses 141 are disposed configures a bottom surface of a recessed portion 15 that is recessed rearward from the front surface 12a of the ferrule 12. In addition, the plurality of ferrule-side lenses 141 are located in the recessed portion 15 such that the plurality of ferrule-side lenses 141 do not protrude outward from the front surface 12a of the ferrule 12. It is noted that the ferrule 12 may not have the recessed portion 15, for example. In this case, the front surface 142a of the intermediate portion 142 may be located on the same plane as the front surface 12a of the ferrule 12.

As shown in FIGS. 2 and 5, in one or more embodiments, the ferrule-side microlens array 13 is formed integrally with the ferrule 12. It is noted that the ferrule-side microlens array 13 may be formed separately from the ferrule 12, for example, and may be fixed to the ferrule 12.

The receptacle 40 shown in FIG. 2 is fixed to the photonic integrated circuit 30. In one or more embodiments, the receptacle 40 is fixed to the circuit-side microlens array 32 of the photonic integrated circuit 30 by adhesion or the like. Thus, the receptacle 40 is fixed to the main body portion of the photonic integrated circuit 30 including the plurality of waveguides 31 via the circuit-side microlens array 32. It is noted that the receptacle 40 may be directly fixed to, for example, the main body portion of the photonic integrated circuit 30 by adhesion or the like. In this case, the receptacle 40 is fixed to the circuit-side microlens array 32 via the main body portion of the photonic integrated circuit 30. In FIG. 2, the receptacle 40 is disposed on the upper surface of the substrate 20, but the present invention is not limited to this.

The ferrule 12 of the optical connection unit 10 is detachably attached to the receptacle 40. In a state in which the ferrule 12 is attached to the receptacle 40, the optical connection unit 10 is positioned with respect to the circuit-side microlens array 32. The receptacle 40 according to one or more embodiments has a protrusion 41 for positioning. The protrusion 41 is inserted into a groove 123 for positioning formed in the ferrule 12, in a state in which the ferrule 12 is attached to the receptacle 40. Thus, the optical connection unit 10 is positioned with respect to the circuit-side microlens array 32. It should be noted that the positioning structure of the optical connection unit 10 by the receptacle 40 is not limited to the above-described configuration, and may be optional.

In addition, although not shown, the receptacle 40 is configured to hold the ferrule 12 attached to the receptacle 40 to prevent the ferrule 12 from being unexpectedly detached from the receptacle 40.

In a state in which the optical connection unit 10 is positioned with respect to the circuit-side microlens array 32, as shown in FIG. 5, the ferrule-side lens 141 of the optical connection unit 10 and the circuit-side lens 321 of the photonic integrated circuit 30 face each other. Specifically, each one of the plurality of ferrule-side lenses 141 and each one of the plurality of circuit-side lenses 321 correspond one-to-one, and each one of the ferrule-side lenses 141 and each one of the circuit-side lenses 321 face in the longitudinal direction X. In addition, the optical axis of each circuit-side lens 321 and the optical axis of each ferrule-side lens 141 substantially match. That is, the optical axis of the waveguide 31 (the incidence and exit portion 31a), the optical axis of the circuit-side lens 321, the optical axis of the ferrule-side lens 141, and the optical axis of the optical fiber 11 substantially match with each other.

As described above, in the optical connection unit 10, two types of optical fibers 11 having different mode field diameters are held by the same ferrule 12. On the other hand, the forms of the plurality of light adjustment units 14 vary depending on the mode field diameter of the optical fiber 11 such that the optical signals emitted from the distal end surfaces 111 of the optical fibers 11 and transmitted through the light adjustment units 14 is parallel light. Hereinafter, this point will be described.

In a case where the mode field diameters of the optical fibers 11 are different from each other, the values of the numerical aperture (NA) of the optical fibers 11 are also different from each other. For example, as the mode field diameter of the optical fiber 11 is larger, the value of the numerical aperture of the optical fiber 11 is smaller. Therefore, in a case where the forms of all the light adjustment units 14 are matched to the mode field diameter of one type of optical fiber 11, the splice loss between the one type of optical fiber 11 and the photonic integrated circuit 30 is reduced, but the splice loss between the other types of optical fibers 11 having different mode field diameters and the photonic integrated circuit 30 is increased.

For example, a case where the mode field diameter of the other type of optical fiber 11 is larger than the mode field diameter of the above-described one type of optical fiber 11 will be considered. In this case, the beam diameter of the optical signal emitted from the other type of the optical fiber 11 continues to be enlarged even in a case where the optical signal passes through the light adjustment unit 14 (ferrule-side lens 141) matched to the one type of the optical fiber 11. That is, the optical signals from the light adjustment units 14 to the photonic integrated circuit 30 side is not parallel light. Further, in a case where the optical signal in which the beam diameter is continuously expanded is condensed in the circuit-side lens 321, the position of the focus of the optical signal is shifted forward (+X direction) with respect to the incidence and exit portion 31a of the waveguide 31. Thus, a splice loss between the other types of optical fibers 11 and the photonic integrated circuit 30 is increased.

Next, a case where the mode field diameter of the other type of optical fiber 11 is smaller than the mode field diameter of the above-described one type of optical fiber 11 will be considered. In this case, the beam diameter of the optical signal emitted from the other type of the optical fiber 11 is reduced by passing through the light adjustment unit 14 (ferrule-side lens 141) matched to the one type of the optical fiber 11. That is, the optical signals from the light adjustment units 14 to the photonic integrated circuit 30 side is not parallel light. Therefore, in a case where the optical signal in which the beam diameter is reduced is condensed in the circuit-side lens 321, the position of the focus of the optical signal is shifted rearward (−X direction) with respect to the incidence and exit portion 31a of the waveguide 31. Thus, a splice loss between the other types of optical fibers 11 and the photonic integrated circuit 30 is increased.

From the above, the forms of the plurality of light adjustment units 14 vary depending on the mode field diameters of the optical fibers 11 such that the optical signals transmitted through the light adjustment units 14 are parallel light. In one or more embodiments, as the forms of the plurality of light adjustment units 14 in which the optical signals transmitted through the light adjustment unit 14 are parallel light, the dimensions L of the intermediate portions 142 of the plurality of light adjustment units 14 (that is, the distance between the distal end surface 111 of the optical fiber 11 and the ferrule-side lens 141) are equal to each other in the longitudinal direction X. Further, the curvature radii of the ferrule-side lenses 141 of the plurality of light adjustment units 14 are different from each other according to the mode field diameters.

Specifically, in the light adjustment unit 14 (first light adjustment unit 14A) corresponding to the first optical fiber 11A having a relatively large mode field diameter, the curvature radius of the ferrule-side lens 141 is large. On the other hand, in the light adjustment unit 14 (second light adjustment unit 14B) corresponding to the second optical fiber 11B having a relatively small mode field diameter, the curvature radius of the ferrule-side lens 141 is small. That is, the curvature radius of the ferrule-side lens 141 is set to be larger as the mode field diameter is larger. Further, the curvature radius of each ferrule-side lens 141 is set such that the optical signals emitted from the distal end surfaces 111 of the optical fibers 11 and transmitted through the ferrule-side lenses 141 are parallel light.

In the first optical fiber 11A having a relatively large mode field diameter, the value of the numerical aperture of the optical fiber 11 is small. Therefore, the beam diameter of the optical signal collimated at the ferrule-side lens 141 is relatively small. On the other hand, in the second optical fiber 11B having a relatively small mode field diameter, the value of the numerical aperture of the optical fiber 11 is large. Therefore, the beam diameter of the optical signal collimated at the ferrule-side lens 141 is larger than the beam diameter of the first optical fiber 11A.

Further, regardless of the mode field diameter of the optical fiber 11, the optical signals from the light adjustment units 14 to the photonic integrated circuit 30 are the parallel light, so that it is possible to effectively prevent the position of the focus of the optical signal condensed in the circuit-side lens 321 from shifting in the longitudinal direction X with respect to the incidence and exit portion 31a of the waveguide 31. Thus, it is possible to reduce the splice loss between the plurality of types of optical fibers 11 having different mode field diameters and the photonic integrated circuit 30.

As described above, an optical connection unit 10 according to one or more embodiments includes a plurality of types of optical fibers 11 having different mode field diameters, a ferrule 12 that holds the plurality of types of optical fibers 11, a ferrule-side microlens array 13 through which an optical signal from a distal end surface 111 of the optical fiber 11 held by the ferrule 12 to a photonic integrated circuit 30 is transmitted, and a plurality of light adjustment units 14 that are disposed in the ferrule-side microlens array 13 and respectively correspond to the plurality of types of optical fibers 11. Further, the forms of the plurality of light adjustment units 14 vary depending on the mode field diameters of the optical fibers 11 such that the optical signals transmitted through the light adjustment units 14 are parallel light. Thus, it is possible to reduce the splice loss between the plurality of types of optical fibers 11 having different mode field diameters and the photonic integrated circuit 30. That is, it is possible to reduce the splice loss between the plurality of types of optical fibers 11 and the photonic integrated circuit 30 without changing the form of the photonic integrated circuit 30.

In addition, in the optical connection unit 10 according to one or more embodiments, the curvature radii of the ferrule-side lenses 141 are different from each other between the plurality of light adjustment units 14 corresponding to the plurality of types of optical fibers 11 having different mode field diameters. Thus, the form of the optical signal between the optical fiber 11 and the photonic integrated circuit 30 can be adjusted to correspond to the plurality of types of optical fibers 11 having different mode field diameters.

In addition, in the optical connection unit 10 according to one or more embodiments, the curvature radius of the ferrule-side lens 141 in each of the plurality of light adjustment units 14 is set such that the optical signals emitted from the distal end surfaces 111 of the optical fibers 11 and transmitted through the ferrule-side lenses 141 are parallel light. Thus, it is possible to reduce the splice loss between the plurality of types of optical fibers 11 having different mode field diameters and the photonic integrated circuit 30.

In addition, in the optical connection unit 10 according to one or more embodiments, the curvature radius of the ferrule-side lens 141 corresponding to the optical fiber 11 having a large mode field diameter is larger than the curvature radius of the ferrule-side lens 141 corresponding to the optical fiber 11 having a small mode field diameter. Thus, it is possible to effectively reduce the splice loss between the optical fiber 11 and the photonic integrated circuit 30.

In addition, in the optical connection unit 10 according to one or more embodiments, the plurality of types of optical fibers 11 include a single mode optical fiber, and a polarization-maintaining optical fiber having a mode field diameter smaller than the mode field diameter of the single mode optical fiber. Therefore, the single mode optical fiber can be used for receiving the optical signal from the photonic integrated circuit 30, and the polarization-maintaining optical fiber can be used for transmitting the optical signal to the photonic integrated circuit 30.

Further, the single mode optical fiber is cheaper than the polarization-maintaining optical fiber. Therefore, by using the single mode optical fiber as the optical fiber 11 for reception, it is possible to reduce the manufacturing cost of the optical connection unit 10 as compared to a case of using the polarization-maintaining optical fiber.

### Second Embodiments

Next, second embodiments will be described, but basic configurations thereof are the same as the configurations of the first embodiments. Therefore, the same reference numerals are given to similar components, the explanation thereof will be omitted, and only difference will be described.

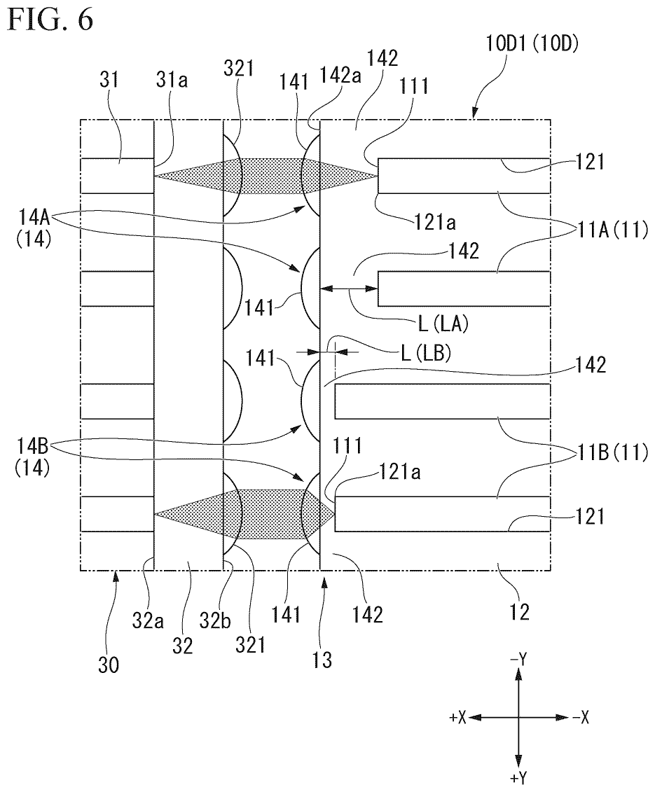

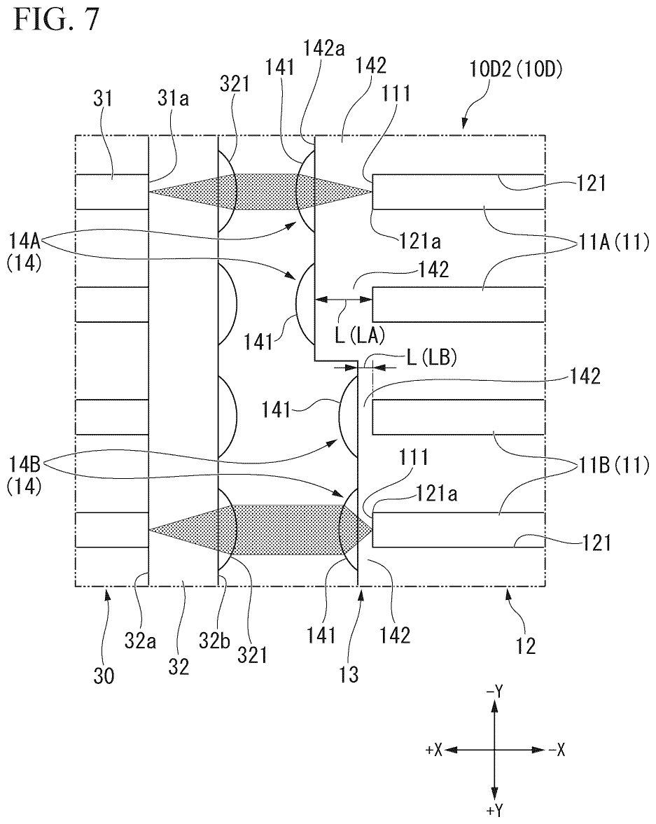

As shown in FIGS. 6 and 7, an optical connection unit 10D according to the second embodiments includes two types of optical fibers 11 (11A and 11B), a ferrule 12, a ferrule-side microlens array 13, and a plurality of light adjustment units 14, in the same manner as in the first embodiments.

In the optical connection unit 10D according to the second embodiments, the forms of the plurality of light adjustment units 14 vary depending on the mode field diameter of the optical fiber 11 such that the optical signals emitted from the distal end surfaces 111 of the optical fibers 11 and transmitted through the light adjustment units 14 are parallel light, as in the first embodiments. Note that, in the second embodiments, the curvature radii of the ferrule-side lenses 141 of the plurality of light adjustment units 14 are equal to each other. Further, in the longitudinal direction X, the dimensions L of the intermediate portions 142 of the plurality of light adjustment units 14 are different from each other in accordance with the mode field diameters.

Specifically, in the first light adjustment unit 14A corresponding to the first optical fiber 11A having a relatively large mode field diameter, the dimension L (LA) of the intermediate portion 142 is large. On the other hand, in the second light adjustment unit 14B corresponding to the second optical fiber 11B having a relatively small mode field diameter, the dimension L (LB) of the intermediate portion 142 is small. That is, the dimension L of the intermediate portion 142 in the longitudinal direction X is set to be larger as the mode field diameter is larger. Further, the dimension L of each intermediate portion 142 is set such that the optical signals emitted from the distal end surfaces 111 of the optical fibers 11 and transmitted through the ferrule-side lenses 141 are parallel light.

In the optical connection unit 10D1 of the first example shown in FIG. 6, the positions of the front surfaces 142a of the intermediate portions 142 in the longitudinal direction X are equal to each other between the first light adjustment unit 14A and the second light adjustment unit 14B. That is, the front surfaces 142a of the plurality of intermediate portions 142 form the same plane. Further, the position of the distal end 121a (distal end surface 111 of the optical fiber 11) of the fiber hole 121 in the longitudinal direction X is different between the first light adjustment unit 14A and the second light adjustment unit 14B. Thus, the dimension L of the intermediate portion 142 in the longitudinal direction X is different between the first light adjustment unit 14A and the second light adjustment unit 14B.

In the optical connection unit 10D2 of the second example shown in FIG. 7, the positions of the distal ends 121a (the distal end surface 111 of the optical fiber 11) of the fiber holes 121 are equal to each other between the first light adjustment unit 14A and the second light adjustment unit 14B. Further, the position of the front surface 142a of the intermediate portion 142 in the longitudinal direction X is different between the first light adjustment unit 14A and the second light adjustment unit 14B. Thus, the dimension L of the intermediate portion 142 in the longitudinal direction X is different between the first light adjustment unit 14A and the second light adjustment unit 14B.

In the optical connection unit 10D of the second embodiments, similarly to the first embodiments, regardless of the mode field diameter of the optical fiber 11, the optical signals from the light adjustment units 14 to the photonic integrated circuit 30 are the parallel light, so that it is possible to effectively suppress the position of the focus of the optical signal condensed in the circuit-side lens 321 from shifting in the longitudinal direction X with respect to the incidence and exit portion 31a of the waveguide 31. Thus, it is possible to reduce the splice loss between the plurality of types of optical fibers 11 having different mode field diameters and the photonic integrated circuit 30.

As described above, with the optical connection unit 10D according to the second embodiments, the same effects as the effects of the first embodiments can be obtained.

In addition, in the optical connection unit 10D according to the second embodiments, the dimensions L of the intermediate portions 142 in the longitudinal direction X are different from each other between the plurality of light adjustment units 14 corresponding to the plurality of types of optical fibers 11 having different mode field diameters. Thus, the form of the optical signal between the optical fiber 11 and the photonic integrated circuit can be adjusted to correspond to the plurality of types of optical fibers 11 having different mode field diameters.

In addition, in the optical connection unit 10D according to the second embodiments, the dimensions L of the intermediate portions 142 in the plurality of light adjustment units 14 are respectively set such that the optical signals emitted from the distal end surfaces 111 of the optical fibers 11 and transmitted through the ferrule-side lenses 141 is parallel light. Thus, it is possible to reduce the splice loss between the plurality of types of optical fibers 11 having different mode field diameters and the photonic integrated circuit 30.

In addition, in the optical connection unit 10D according to the second embodiments, the dimension L (LA) of the intermediate portion 142 corresponding to the optical fiber 11 having a large mode field diameter is larger than the dimension L (LB) of the intermediate portion 142 corresponding to the optical fiber 11 having a small mode field diameter. Thus, it is possible to effectively reduce the splice loss between the optical fiber 11 and the photonic integrated circuit 30.

It should be noted that the technical scope of the present invention is not limited to the above-described embodiments, and various modifications can be made without departing from the scope of the present invention.

In the present invention, the two types of optical fibers 11 provided in the optical connection unit may be, for example, two types of single mode optical fibers having different mode field diameters.

In addition, in the present invention, the optical connection unit 10 may have, for example, three or more types of the optical fibers 11 having different mode field diameters.

In the present invention, the optical axis of the circuit-side lens 321 and the optical axis of the ferrule-side lens 141 may not substantially match. In a case in which the optical signal can be transferred between the circuit-side lens 321 and the ferrule-side lens 141, the optical axis of the circuit-side lens 321 and the optical axis of the ferrule-side lens 141 may be shifted or inclined with respect to each other. In addition, a distance between the circuit-side lens 321 and the ferrule-side lens 141 in the longitudinal direction X may be appropriately changed.

Similarly, in the present invention, the optical axis of the waveguide 31 and the optical axis of the circuit-side lens 321 may not substantially match, for example. In a case in which the optical signal can be transferred between the waveguide 31 and the circuit-side lens 321, the optical axis of the waveguide 31 and the optical axis of the circuit-side lens 321 may be shifted or inclined with respect to each other. Alternatively, the distance in the longitudinal direction X between the incidence and exit portion 31a and the circuit-side lens 321 may be appropriately changed.

Similarly, in the present invention, the optical axis of the ferrule-side lens 141 and the optical axis of the optical fiber 11 may not substantially match, for example. In a case where the optical signal can be transferred between the ferrule-side lens 141 and the optical fiber 11, the optical axis of the ferrule-side lens 141 and the optical axis of the optical fiber 11 may be shifted or inclined with respect to each other.

In the present invention, the optical connection unit 10 may be attachable to and detachable from the photonic integrated circuit 30 as in the above-described embodiments, but may be provided not to be attachable to and detachable from the photonic integrated circuit 30.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

10, 10D, 10D1, 10D2: Optical connection unit
11: Optical fiber
111: Distal end surface
12: Ferrule
13: Ferrule-side microlens array
14: Light adjustment unit
141: Ferrule-side lens
142: Intermediate portion
30: Photonic integrated circuit
L: Dimension of intermediate portion 142

1. An optical connection unit connected to a photonic integrated circuit, comprising:
optical fibers having different mode field diameters;
a ferrule that holds the optical fibers;
a ferrule-side microlens array that transmits optical signals from distal end surfaces of the optical fibers held by the ferrule toward the photonic integrated circuit; and
light adjustment units in the ferrule-side microlens array that respectively correspond to the optical fibers, wherein
the light adjustment units vary in shape depending on the mode field diameters such that the optical signals transmitted through the light adjustment units become parallel light.

2. The optical connection unit according to claim 1, wherein
each of the light adjustment units comprises:
a lens that faces a distal end surface of a corresponding one of the optical fibers; and
an intermediate portion between the lens and the distal end surface,
the intermediate portions of the light adjustment units have equal lengths in a longitudinal direction of the corresponding ones of the optical fibers, and
the lenses of the light adjustment units have different curvature radii depending on the mode field diameters of the corresponding ones of the optical fibers.

3. The optical connection unit according to claim 2, wherein the larger the mode field diameters of the corresponding ones of the optical fibers, the larger the curvature radii of the lenses of the light adjustment units.

4. The optical connection unit according to claim 1, wherein
each of the light adjustment units comprises:
a lens that faces a distal end surface of a corresponding one of the optical fibers; and
an intermediate portion between the lens and the distal end surface,
the lenses of the light adjustment units have equal curvature radii, and
the intermediate portions of the light adjustment units have different lengths in a longitudinal direction of the corresponding ones of the optical fibers depending on the mode field diameters of the corresponding ones of the optical fibers.

5. The optical connection unit according to claim 4, wherein the larger the mode field diameters of the corresponding ones of the optical fibers, the longer the lengths of the intermediate portions of the light adjustment units.

6. The optical connection unit according to claim 1, wherein the optical fibers include:
a single mode optical fiber; and
a polarization-maintaining optical fiber having a mode field diameter smaller than a mode field diameter of the single mode optical fiber.

7. The optical connection unit according to claim 2, wherein the optical fibers include:
a single mode optical fiber; and
a polarization-maintaining optical fiber having a mode field diameter smaller than a mode field diameter of the single mode optical fiber.

8. The optical connection unit according to claim 3, wherein the optical fibers include:
a single mode optical fiber; and
a polarization-maintaining optical fiber having a mode field diameter smaller than a mode field diameter of the single mode optical fiber.

9. The optical connection unit according to claim 4, wherein the optical fibers include:
a single mode optical fiber; and
a polarization-maintaining optical fiber having a mode field diameter smaller than a mode field diameter of the single mode optical fiber.

10. The optical connection unit according to claim 5, wherein the optical fibers include:
a single mode optical fiber; and
a polarization-maintaining optical fiber having a mode field diameter smaller than a mode field diameter of the single mode optical fiber.
